(19) United States
(12) Patent Application Publication
(10) Pub. No.: US 2010/0028068 A1
(43) Pub. Date: Feb. 4, 2010

(54) Correction Stick Equipped Pen and Pen Cap

(76) Inventor: Julius M. Razalan, Long Beach, CA (US)

Correspondence Address: BERENATO & WHITE, LLC, 6550 ROCK SPRING DRIVE, SUITE 240, BETHESDA, MD, 20817, US

(21) Appl. No.: 12/344,299

(22) Filed: Dec. 26, 2008

Related U.S. Application Data
(60) Provisional application No. 61/085,484, filed on Aug. 1, 2008.

(51) Int. Cl. B05C 11/00

(52) U.S. Cl. 401/17

(57) ABSTRACT

A correction stick equipped pen and pen cap relating to an ink pen with a detachable pen cap, wherein the pen has a dual purpose of writing with ink on one end and whiting out mistakes on the other end with a correction stick; and the pen cap also has a dual purpose of capping the pen and whiting out mistakes with a correction stick as well. It includes a main tubular body having a first end portion comprising a writing end and a second end portion comprising a correcting end wherein the second end portion is formed with a neck with an inner circular flange and a circular recess above said circular flange wherein a correction stick is snugly-fitted into said circular recess; and a correction stick equipped pen cap, wherein a correction stick is snugly seated at a circular recess at the tip of the said pen cap.

This application claims the benefit of U.S. Provisional application 61/085,484, filed Aug. 1, 2008.

### BACKGROUND OF THE INVENTION

1. Field of the Invention

The invention relates generally to a Correction Stick Equipped Pen and Pen Cap

2. Background

It is inherent in human nature to make errors in writing characters on paper or similar substrate. The use of an eraser-equipped pencil or eraser-equipped erasable ink pen has proven to be very convenient for the writer in making quick erasure of any mistakes in writing. However, in many cases, the use of a non-erasable ink pen is more desirable because of its permanency especially when it is used in legal documents and the like. There are three different correction materials sold on the marketplace which can be used to correct errors made on a substrate using a non-erasable ink pen. These include the correction fluid, the correction tape, and last, but not least, the correction stick. However, each of these correction materials that are presently available in the market is housed in its own discrete and separate dispensing container. In other words, none of them is built into or incorporated into an ink pen. It is apparent, therefore, that it would be more convenient to have a pen with a corrective function. This is because the user of the pen would not need to look and search for a separate instrument in order to correct any mistakes in writing or drawing. The user would simply use the corrective element of the same instrument, such as, by simply inverting the device in order to white out an error in writing.

There are a number of known patented combination writing/correcting instruments. Some are available in the marketplace and some are not. So far, the corrective material housed or mounted in all of these known instruments includes correction fluid, correction tape, ink eradicator, or eraser. However, none of these instruments use correction stick as the corrective material. The incorporation of correction fluid or correction tape to a writing implement is complex, requires more raw materials, is more prone to malfunction and is inevitably more costly compared to that of the present invention. The incorporation of ink eradicator to a writing implement is also inferior compared to the present invention because the ink eradicator can only eradicate characters dispensed by a pen whose ink is of a certain chemical composition. In other words, in contrast to the present invention, the ink eradicator cannot white out characters dispensed by most regular ink pens, pencils, markers, printers, fax machines and so on. The same goes with eraser equipped pens. The eraser of the device can only eradicate characters dispensed in ink of a certain chemical composition, also known as “erasable ink”. Furthermore, a correction stick housed in a pen-like structure is known, but obviously, this device lacks the writing capability that the present invention has.

Correction stick is available in the market in such forms as the QuickFix Correction Stick by manufacturer Avery-Dennison. Correction stick is also described in U.S. Pat. No. 5,147,457, U.S. Pat. No. 4,992,502 and U.S. Pat. No. 5,403,872. Correction stick is a solid correction material that is used for covering writing or drawing mistakes by simply rubbing the material over an area to be corrected.

### SUMMARY OF THE INVENTION

The present invention relates to combination writing/correcting instruments. More particularly, it relates to a correction stick equipped pen and pen cap. Specifically, it relates to an ink pen with a detachable pen cap, wherein the pen has a dual purpose of writing with ink on one end and whiting out mistakes on the other end with a correction stick; and the pen cap also has a dual purpose of capping the pen and whiting out mistakes with a correction stick as well.

The present invention is a correction stick equipped pen and pen cap, which is made up of the following elements: (1) a holder with a first end portion and second end portion; (2) a writing end; (3) a correcting end; (4) a correction stick; and (5) a pen cap with a correction stick at its tip. These elements are related or connected as follows: the writing end is attached or fitted into the first end portion of the holder; the correcting end is connected or is part of the second end portion of the holder; the replaceable correction stick is snugly fitted into a recess of the correcting end; and the detachable pen-cap with a correction stick at its tip can be placed to cap the writing end or the correcting end depending on where the user wants it to be placed.

The correction stick has several advantages over correction fluid. Unlike the correction fluid, the correction stick won't spill; it won't clump or clog; can copy or fax immediately; and can be written on or typed over immediately. Moreover, each of the patented combination writing/correcting instruments found in literature that uses correction fluid as the corrective material, are necessarily complex in construction because of the nature of the corrective material, that is, its liquid. Among other requirements, the liquid must be contained in a sealed cartridge/container. In most cases the cartridge/container must be detachable from the instrument and the instrument has to have some sort of applicator such as a brush or steel ball through which the liquid will flow and be dispensed onto an area to be corrected. Also, because of the chemical nature of correction fluid, the correction fluid reservoir and its dispensing areas must be diligently cleaned and maintained on a regular basis or else dried up residual correction fluid could build up, cause clumps, and cause clogs and, hence, could render the instrument less functional in its correcting capability. Hence, a correction fluid equipped pen will be costly both to the manufacturer and the consumer and it could also become inconvenient and a nuisance to the user. In contrast, correction stick is a white solid material (similar to a chalk or crayon), so it does not need to be contained in a cartridge or container like with correction fluid.

The correction stick also has some advantages over the correction tape, more specifically in the mechanism or means required for it to be dispensed. The means of dispensing correction tapes is complex requiring one or two rotating reels where the correction tape is wound and a guiding tip to guide the tape onto the area to be corrected. Also, with correction tapes, the tape could become loose, come out of the guiding tip, come out of the reels, and it could also break. All these drawbacks could render the instrument useless. For examples, there are two patented inventions in the literature that are correction tape equipped writing implements, namely U.S. Pat. No. 6,461,068 and U.S. Pat. No. 6,921,223. Similar to correction fluid equipped pens, the correction tape in these inventions are housed in a complex detachable correction tape dispenser. If all of the correction tape were used up, the user would have to replace this whole tape dispenser apparatus with a new one. Because of this, the cost will be high for both the manufacturer and the consumer. Correction stick, on the other hand, is a solid material that does not need to be housed in special container or wound up on a reel as with correction tape.

Correction stick is therefore a useful and efficient corrective material. However, as implied earlier, the correction stick available in the market today is contained in its own discrete dispensing container device so that one must purchase and carry this device in addition to a writing or drawing instrument. This makes it inconvenient to use and also wastes time and money.

The primary objective of the present invention is to provide convenience for the user of the pen by having a pen with, not only a writing or drawing function, but also a corrective function as well. The invention achieves this objective by having a linear and tubular pen with one end having the means to dispense ink when writing or drawing and the other end having a correction stick snugly seated on a circular recess thus providing the means to dispense the correction material when needed for correction. In addition, the pen cap also adds to this convenience by having a circular recess at its tip where a correction stick is also snugly fitted, thereby rendering the pen with another means of dispensing the correction material.

Another objective of the invention is to provide a correction stick equipped pen and pen cap that minimizes cost to the manufacturer and consumer alike. This is achieved through the invention's utmost simple design and construction.

Another objective of the invention is to provide, by design and construction, an easy, simple and cost effective way of replacing the correction supply. This is achieved by having a circular recess at the rear end of the pen and at the tip of the pen cap where a new naked correction stick can simply be inserted when needed.

Another main objective of the invention is to provide a unique pen cap that has a dual purpose of capping pen and whiting out mistakes in writing or drawing. This is also achieved by having a circular recess at the tip of the pen cap where a correction stick is snugly fitted. It should be noted that this unique pen cap could also be used to cap any other appropriate size writing implement, rendering that writing implement with an immediate capability of whiting out mistakes in addition to writing characters on a substrate.

The present invention is unique and superior when compared with other known devices and solutions because the present invention provides: (1) increased convenience by allowing the use of an implement with not only a writing function but also with its own corrective function that, as explained earlier, utilizes a superior corrective material known as the correction stick; (2) minimized cost to the manufacturer and consumer through the invention's utmost simple design and construction; (3) simple and cost effective way of replacing the correction supply; (4) a unique pen cap that has a dual purpose of capping the pen and whiting out mistakes with the same superior corrective material. In addition, the said pen cap could also be used to cap any other appropriate size writing implement, rendering that writing implement with an immediate capability of whiting out mistakes using a superior corrective material.

The present invention is unique in that it is structurally different from other known devices or solutions. More specifically, the present invention is unique due to the presence of a correction stick mounted on one end of a pen and also on the pen cap. This is achieved by having a linear and tubular pen with one end having the means to dispense ink when writing or drawing and the other end having a correction stick snugly seated on a circular recess thus providing the means to dispense the correction material when needed for correction. In addition, the pen cap also has a circular recess at its tip where a correction stick is also snugly fitted, thereby rendering the pen with another means of dispensing the correction material. The pen cap size, structure and design also enable the pen cap to fit any regular size writing implement which will render said implement the immediate ability to have its own correction stick corrective function. Overall, this utmost simplicity in design and structure as described allows for an easy and cost effective way of replacing the correction supply, and also minimizes cost to the manufacturer and consumer alike.

Finally, it is an object of the present invention to provide a correction stick equipped pen and pen cap that does not suffer from any of the problems or deficiencies associated with prior solutions.

The foregoing summary of the invention is only a brief introduction of the invention. In order to fully appreciate the objects of the invention and the invention itself and also manifest other advantages and features of the invention, the following detailed description and claims should be read with reference to the accompanying drawings. The drawings shown illustrate a preferred structural embodiment of the present invention. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 shows a perspective view of the present invention where all elements are attached including the detachable pen cap.

FIGS. 2 and 3 show perspective views of the present invention when the pen cap is removed from the writing end exposing the writing end (FIG. 2), when the pen cap is capping the correcting end, and when all the mini caps are removed (FIG. 3).

FIG. 4 is an assembled view of the pen cap of the present invention.

FIG. 5 is an exploded view of the pen cap of the present invention.

FIG. 6 is an exploded view of the present invention.

FIG. 7 is a close up and cross sectional view of the present invention where details of the various attachments and engagements of the parts of the invention are vividly shown.

### DETAILED DESCRIPTION OF THE INVENTION

The present invention is directed to a correction stick equipped pen and pen cap.

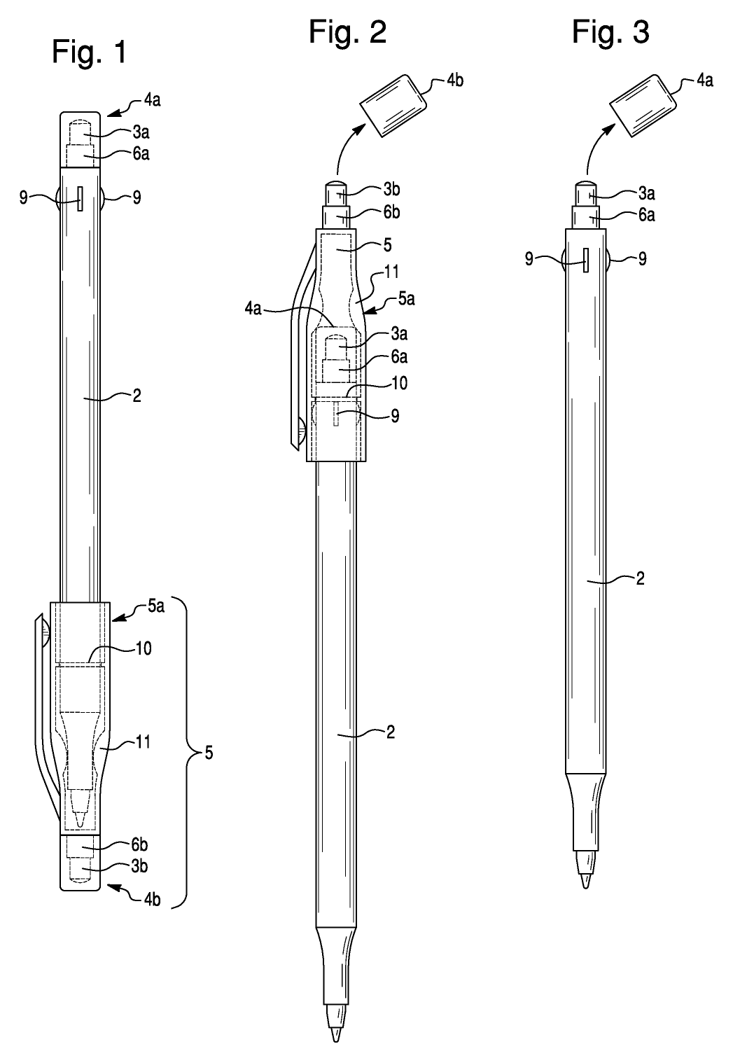

Referring to the drawings FIGS. 1-7, the correction stick equipped pen and pen cap comprises the following components:

A main tubular body (the holder) 2;

Inner ink chamber and dispenser apparatus (the writing end) 1;

Correction sticks 3a and 3b;

Correction stick mini caps 4a and 4b; and,

Pen Cap 5.

The upper end of the main tubular body 2 is formed with a neck 6a whose diameter is slightly smaller than the diameter of the main tubular body 2. The inside bottom part of the neck 6a is formed with an inner circular flange 7a. This forms a circular recess 8a right above this flange 7a. This circular recess 8a is where the correction stick 3a is snugly fitted. A mini cap 4a caps the correction stick 3a and the neck 6a. Basically, the lower half of the mini cap 4a is engaged with the neck 6a of the main tubular body 2.

Below the neck 6a of the upper end of the main tubular body 2 are four small evenly spaced triangular protrusions 9. These will hold the pen cap 5 when the pen cap is used to cap the upper end of the pen. When the pen cap 5 is engaged to cap the upper (rear) end of the pen, the triangular protrusions 9 will abut against an inner circular flange 10 of the pen cap 5 thereby serving as a guide and stopper to prevent the pen cap 5 from being advanced too deep when capping. It is important that the pen cap 5 is not advanced too deep when capping the upper (rear) end of the pen so that the pen cap 5 will not engage the mini cap 4a and or the correction stick 3a.

The tubular ink chamber 1a and neck 1b of the ink chamber and dispenser apparatus 1 is fitted within the main tubular body 2 with the ink chamber neck 1b engaged against the inner side walls of the lower end of the main tubular body 2.

The pen cap 5 comprises the following engageable but also separable parts: the pen cap body 5a, the correction stick 3b, and the mini cap 4b. The pen cap 5 caps the writing end of the pen by engaging with the head 1c of the ink chamber and dispenser apparatus 1 and the lower end of the main tubular body 2. More specifically, the head 1c engages with the inner thickened wall area 11 of the pen cap body 5a; and the lower end of the main tubular body 2 engages with inner circular flange 10, an upper inner thickened wall of the pen cap body 5a (see FIG. 5).

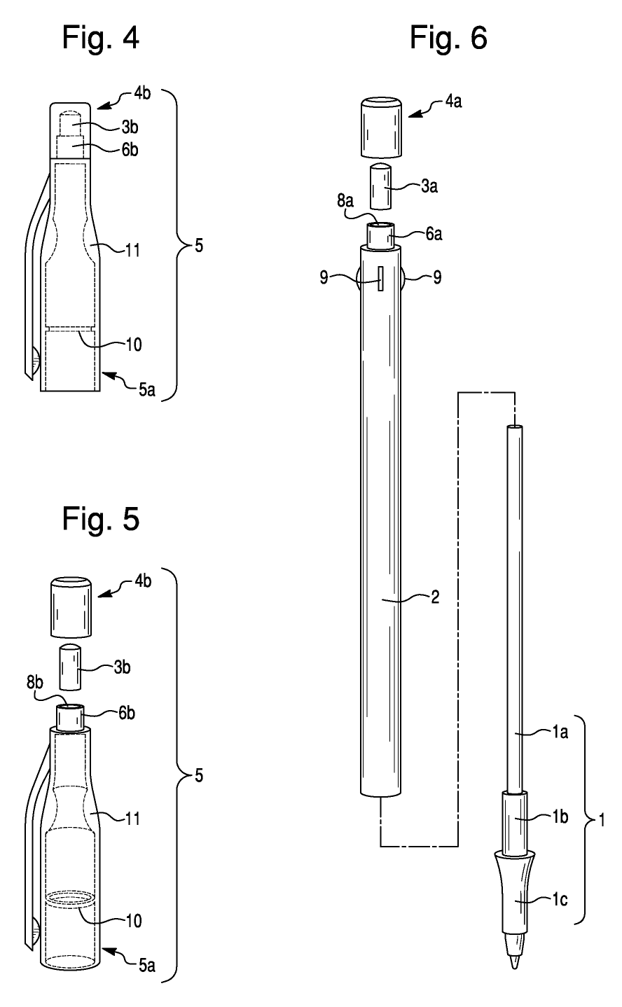

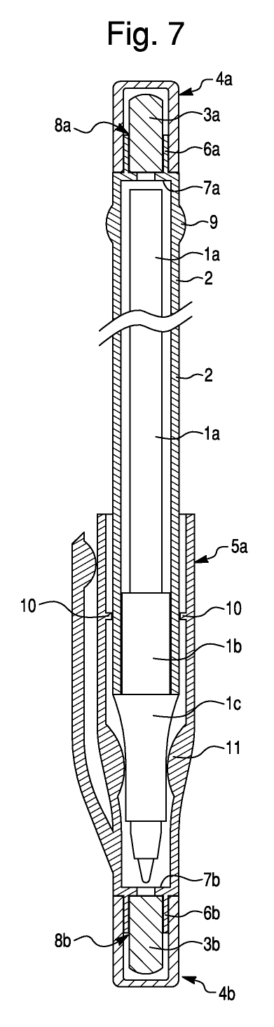

Based on the orientation of the pen cap 5 as shown in FIGS. 4 and 5, the pen cap body 5a is formed with a lower inner circular flange 10, an upper inner thickened wall 11, and an upper neck 6b. Looking at the orientation and cross sectional view as shown in FIG. 7, the lower neck 6b is formed with a smaller inner circular flange 7b (but the same size of that of 7a) and a circular recess 8b right below this circular flange 7b. The correction stick 3b (which has the same size and composition as correction stick 3a) is snugly fitted into the circular recess 8b. The engageable mini cap 4b (which is the same size and composition as mini cap 4a) caps the correction stick 3b and the lower neck 6b. Basically, the lower half (orientation based on FIGS. 4 and 5) of the mini cap 4b is engaged with the neck 6b of the pen cap body 5a.

In order for the user to utilize the present invention to write or draw, he or she needs to pull the pen cap 5 off. The user then has two choices as to what to do next with the pen cap 5. The user can either keep the pen cap 5 detached from the pen or the user can engage the pen cap 5 on the other (rear) end of the pen. The components that interact in this engaging process have been previously described.

When the user of the invention makes an error in writing or drawing and the user desires to use the invention to correct or white out the mistake, then the user has the following options. If the pen cap 5 is detached from the pen, the user can remove the mini cap 4a from the opposite or rear end of the pen exposing the correction stick 3a and simply invert the pen and rub the correction stick 3a over the area to be corrected to white out or apply the corrective material over the mistake. The user can also use the detached pen cap 5 by itself to correct the mistake. The user simply removes the mini cap 4b and while holding onto the pen cap body 5a, rubs the correction stick 3b over the area to be corrected to white out the mistake. On the other hand, if the pen cap 5 is already engaged on the opposite end of the pen (as shown in the first drawing of FIG. 2), then the user can simply remove the mini cap 4b to expose the correction stick 3b, invert the instrument, and rub the correction stick 3b over the area to be corrected.

Having a correction stick equipped pen cap renders the correction stick equipped pen with two possible sites of corrective function: (1) the rear or opposite end of the pen and (2) the tip of the pen cap. When the correction stick of one site is used up, then the user can use the other one. If the pen cap is lost or misplaced, then the pen still has its own corrective element located at its rear or opposite end. If the pen itself is lost or misplaced but the pen cap is around, the pen cap can be used to cap any other suitable regular pen rendering the said pen the immediate capability of a corrective function.

Furthermore, it should also be noted that because of the utmost simplicity in design and construction of the present invention and the solid nature of the corrective material as described earlier, replacing the correction stick with a new one is very easy, simple, convenient and cost effective. The replacement correction stick is purely self contained and does not need to be housed in a cartridge like correction fluid or correction tape as previously described. In order to refill the present invention with a new correction stick, the user can simply insert a new one into the designed circular recess located at the rear end of the pen or at the tip of the pen cap.

The present invention can also have one or more of the following: (1) mini cap, which caps the correction stick of the correcting end by engaging the second end portion; (2) another mini cap, which caps the correction stick of the pen cap; and (3) a soft grip, which is attached near the first end portion of the holder. It should further be noted that: (a) the holder can be made of various materials, such as but not limited to wood, plastics, metals, metal alloys, but plastics are preferable; (b) the writing end can be made of various materials, such as but not limited to aluminum, wood, steel, metal alloy, plastic, but metal and plastic are preferable; the writing end is most preferred to be an ink pen but it could also comprise a graphitic writing tip (such as a pencil) or a permanent marker; (c) the soft grip could can be made of plastic, rubber, or foam, but rubber is preferable; (d) the pen cap and mini caps could be made of wood, aluminum, plastics, steel, metal alloy, but plastic is preferable; and (e) all of the above mentioned connections and attachments can be achieved through various means such as, but not limited to, the use of various adhesives, friction, tight fitting, locking mechanisms such as the use of internal and external threads, but simple tight snug fitting is preferred.

The invention can be constructed or assembled in a different way to achieve the same primary objective. The invention could be constructed without the dual-purpose pen cap.

In other words, the invention could just have a regular pen cap and the pen would be the only one having the corrective element. The invention could be constructed without a pen cap at all. The invention could also be constructed with only the pen cap having the corrective function.

Based on what is available in the market today, there are numerous ways and combination of ways the invention could be constructed to achieve the same primary objective. All of the connections and attachments described can also be achieve through other various or combination of various means such as but not limited to the use of various adhesives, friction, locking mechanisms such as the use of internal and external threads, etc. In addition, the invention could be constructed where the correction stick is advanced telescopically with a twisting motion of the body of the pen or of the pen cap. The invention could also be constructed where both the writing tip and the correction stick are both exposed through a rotating or twisting motion. The writing tip could also be the only one that is exposed through a rotating motion and not the correction stick, and vice versa. The writing tip could also be exposed by clicking the pen just like the way many click pens work. The correction stick could also be exposed using a retracting or sliding motion. Anyone skilled in the art could see that there are many varied ways that this invention can be assembled to meet the primary objective. However, I think it would also be apparent to those skilled in the art that most, if not all, of these alternative ways of assembly will most probably cost more to the manufacturer and to the consumer because of their increased complexity and increased requirement of raw materials.

There are different ways the present invention may be used. This invention is designed primarily to have the capability or function of whiting out mistakes in writing or drawings that were made using the same device. In addition to this primary objective, the corrective part of the instrument can also be used to correct or white out mistakes or errors made by other devices such as computer printers, copiers, fax machines, inkjet printers, laser printers, or paint brushes.

In addition to whiting out mistakes in writing, drawing, painting or prints, the corrective part of the instrument can be used for any purpose the user of the instrument feels appropriate. In other words, the corrective part of the device is not for the sole purpose of whiting out mistakes; it can also be used for the purpose of covering or hiding written, typewritten or printed information; it can also be used for aesthetic or artistic work.

The present invention is not limited to the particular features or to the details of the preferred embodiment specified in the foregoing. It is therefore understood that upon reading and understanding the specifications and claims of this invention, those skilled in the art can make numerous modifications, omissions, changes, and substitutions in the preferred embodiment, in the forms and details of the instrument, and in its operation, as long as they fall within the scope of present invention.

What is claimed is:

1. A combination correction stick equipped pen and pen cap comprising:
a main tubular body having a first end portion and a second end portion, wherein said first end portion comprises a writing end and wherein said second end portion comprises a correcting end, said second end portion formed with a neck including an inner circular flange and a circular recess directly above said circular flange wherein a correction stick is snugly fitted into said circular recess; and,
a correction stick equipped pen cap engageable with either of said first end portion or said second end portion of said main tubular body, wherein a tip of said pen cap is formed with a neck with a second circular recess wherein a correction stick is snugly fitted into said second circular recess.

2. The device of claim 1 wherein the said writing end comprises a non-erasable ink pen.

3. The device of claim 1 wherein the said writing end comprises an erasable ink pen.

4. The device of claim 1 wherein the said writing end comprises a permanent marker.

5. The device of claim 1 wherein the said writing end comprises a graphitic writing tip.

6. The device of claim 1 wherein the correction stick is capped with a first mini cap which is engaged with said neck of said second end portion of said main tubular body.

7. The device of claim 1 wherein the correction stick of said pen cap is capped with a second mini cap through engagement of said second mini cap with said tip of said pen cap.

8. The device of claim 1 further comprising a soft grip surround attached near the first end portion of the said main tubular body and wherein said soft grip is preferably made of rubber.

9. A process for correcting a mistake when using a pen for marking on a substrate, said pen equipped with a pen cap including an inserted correction stick; comprising the steps of:
marking on said substrate and making a mistake;
removing a mini cap engaged with said pen cap to expose said correction stick inserted inside an end of said pen cap, said pen cap being removeably engaged on a non-writing 11 end of said pen, and inverting said pen and rubbing said correction stick on said substrate so as to apply a corrective material comprising said correction stick over an area of said substrate including said mistake.

10. A combination correction stick equipped pen cap and pen comprising:
a main tubular body having a first end portion and a second end portion, wherein said first end portion comprises a writing end and wherein said second end portion comprises a non-writing end; and,
a correction stick equipped pen cap engageable with either of said first end portion or said second end portion of said main tubular body, wherein a tip of said pen cap is formed with a neck with a circular recess wherein a correction stick is snugly fitted into said circular recess.

11. A process for correcting a mistake when using a pen for marking on a substrate, said pen equipped with a correction stick mounted on the opposite end of said pen used for marking; comprising the steps of:
marking on said substrate and making a mistake;
removing a mini cap engaged with said opposite end of said pen to expose said correction stick inserted inside a circular recess inside said opposite end of said pen, and inverting said pen and rubbing said correction stick on said substrate so as to apply a corrective material comprising said correction stick over an area of said substrate including said mistake.

12. A process for correcting a mistake when using a pen for marking on a substrate and a correction stick equipped pen cap is by itself, detached from the said pen; comprising the steps of:
marking on said substrate and making a mistake;
removing a mini cap engaged with said pen cap to expose said correction stick inserted inside an end of said pen cap, said pen cap being by itself detached from said pen, and inverting the said pen cap and rubbing said correction stick on said substrate so as to apply a corrective material comprising said correction stick over an area of said substrate including said mistake.
